(19) United States
(12) Patent Application Publication
(10) Pub. No.: US 2010/0312784 A1
(43) Pub. Date: Dec. 9, 2010

(54) NOTIFICATION-BASED CACHE INVALIDATION FOR COMPLEX DATABASE QUERIES

(75) Inventors: Christopher Andrew Boyd, Seattle, WA (US); Boaz Lev, Redmond, WA (US); Jivko Varbanov Kolev, Seattle, WA (US); Christopher Alan Elwell, Redmond, WA (US); Michael Shawn Garlick, Bothell, WA (US)

Correspondence Address: MICROSOFT CORPORATION, ONE MICROSOFT WAY, REDMOND, WA, 98052, US

(73) Assignee: Microsoft Corporation, Redond, WA (US)

(21) Appl. No.: 12/479,878

(22) Filed: Jun. 8, 2009

(51) Int. Cl. G06F 17/30

(52) U.S. Cl. 707/769; 707/812; 707/708

(57) ABSTRACT

A secondary database query is registered for a change notification with a database server. The secondary database query is a database query that is eligible for a change notification from the database server and that is configured to return a superset of the data returned by a corresponding complex database query that is ineligible for a change notification. If a change notification is received from the database server for the secondary database query, an entry in a database query result cache corresponding to the complex database query is invalidated.

### BACKGROUND

Certain database server programs (“database servers”) provide functionality for registering a database query for a change notification (also referred to herein as a “query notification”). A change notification is an asynchronous notification that is provided by the database server when the data underlying a registered database query changes.

Through the use of change notifications and a database query result cache for storing previous database queries, unnecessary database queries can be avoided for data that does not change or that only changes infrequently. Certain types of complex database queries, however, are ineligible for change notifications. As a consequence, query results from this type of database query, which is referred to herein as a “complex database query”, cannot typically be cached. This can affect the performance of certain types of application programs that utilize complex queries.

It is with respect to these and other considerations that the disclosure presented herein has been made.

### SUMMARY

Concepts and technologies are described herein for notification-based cache invalidation for complex database queries. According to embodiments presented herein, change notifications can be provided for complex database queries that are otherwise ineligible for a change notification provided by a database server. Through the use of such a mechanism, it can be determined whether the data underlying a complex database query has changed without polling a database server to determine if the data has changed.

According to one embodiment presented herein, a database query result cache is provided for caching database query results. The database query result cache includes entries storing query results that can be indexed based upon the corresponding query. When a database query is to be performed, a search is made of the database query result cache to determine whether it includes an entry corresponding to the database query. If so, the database query results stored in the database query result cache are returned. In this way, it is not necessary to perform database queries for those database queries that have been previously cached.

Change notifications provided by a database server may be utilized to invalidate entries in the database query result cache. For instance, if a database query is eligible for a change notification, a request may be made to the database server to register the database query for a change notification. If the set of data returned by the database query changes, the database server will provide a change notification. In response to receiving the change notification, the entry in the database query result cache for the corresponding database query is invalidated. For instance, in one embodiment, the entry in the database query result cache for the corresponding database query is deleted.

A mechanism is also provided herein for invalidating database query result cache entries for database queries that are ineligible for a change notification from the database server. This type of database query is referred to herein as a “complex database query.” In order to invalidate a database query result cache entry corresponding to a complex database query, a secondary database query is registered for a change notification with the database server. In one implementation, the secondary database query is a database query that is eligible for a change notification from the database server and that is configured to return a superset of the data returned by the corresponding complex database query.

If a change notification is received from the database server for a secondary database query, the entry in the database query result cache corresponding to the complex database query is invalidated. In this way, an entry in a database query result cache corresponding to a complex database query can be invalidated even though the complex database query is ineligible for a change notification from the database server.

It should be appreciated that the above-described subject matter may also be implemented as a computer-controlled apparatus, a computer process, a computing system, as an article of manufacture such as a computer readable storage medium, or in another manner. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a computer software architecture diagram that illustrates aspects of the operation of a database query result cache in various embodiments presented herein;

FIG. 2 is a flow diagram showing one illustrative process for caching database query results;

FIG. 3 is a computer software architecture diagram that illustrates aspects of a mechanism for registering with a database server for a change notification;

FIGS. 4A and 4B are flow diagrams showing processes for registering for a change notification and for processing a change notification, respectively, according to one embodiment presented herein;

FIG. 5 is a computer software architecture diagram that illustrates aspects of one mechanism provided herein for invalidating database query result cache entries for complex database queries that are ineligible for change notifications according to one embodiment;

FIGS. 6A and 6B are flow diagrams showing processes for registering a secondary database query for a change notification and for invalidating a database query result cache entry for a complex database query, respectively, according to one embodiment presented herein;

FIGS. 7A and 7B are flow diagrams showing processes for registering for a change notification and for processing a change notification, respectively, according to one embodiment presented herein; and

FIG. 8 is a computer architecture diagram showing an illustrative computer hardware and software architecture for a computing system capable of implementing aspects of the embodiments presented herein.

### DETAILED DESCRIPTION

The following detailed description is directed to technologies for notification-based cache invalidation for complex database queries. While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements throughout the several figures, concepts and technologies for notification-based cache invalidation for complex database queries will be described.

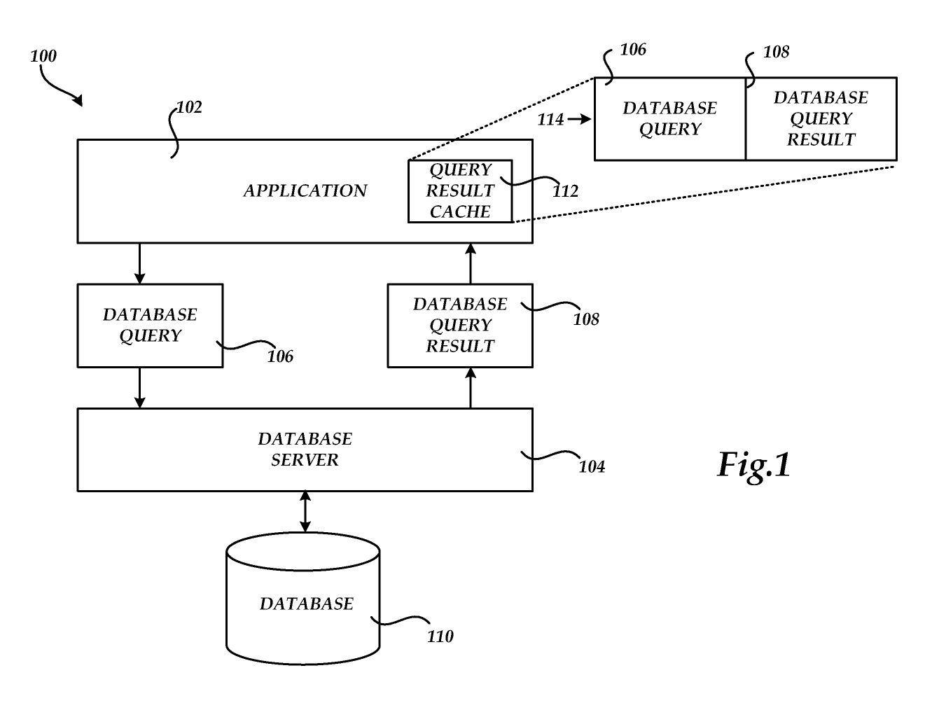

Turning now to FIG. 1, a computer software architecture diagram that illustrates aspects of a system 100 capable of caching database queries will be described. As shown in FIG. 1, the system 100 includes a database server 104 that is configured to receive a database query 106 from an application program 102. The database query 106 is utilized by the database server 104 to query the database 110 and to provide a database query result 108 to the application program 102 in response thereto. It should be appreciated that the system 100 shown in FIG. 1 has been simplified for discussion purposes and that additional or fewer software components may be utilized other than those shown in FIG. 1. It should also be appreciated that the components illustrated in FIG. 1 may be connected by various local or wide area networks according to implementations presented herein.

In one embodiment presented herein, the database server 104 comprises a structured query language (“SQL”) database server that is configured to receive a database query 106 formatted using SQL. It should be appreciated, however, that the embodiments presented herein may be utilized with any type of database server 104 configured for processing database queries structured utilizing other types of database query languages. It should also be appreciated that the application 102 may generate the database query 106 in one embodiment. In other embodiments, the application 102 receives a database query 106 from another software component executing within the application 102 or external to the application 102, and passes the database query 106 to the database server 104 for processing.

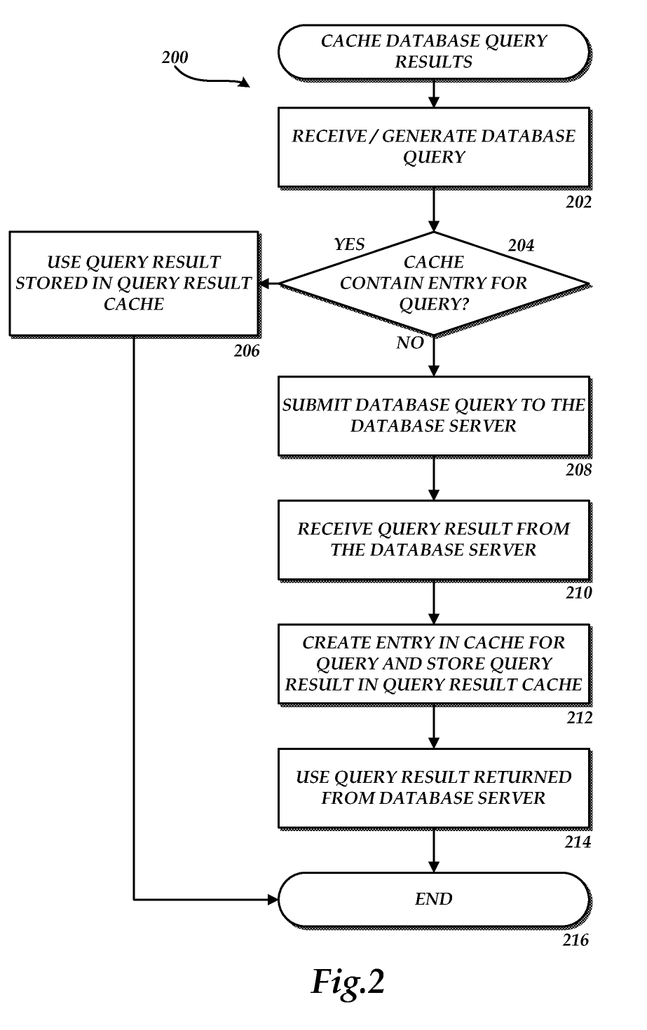

According to implementations, the application 102 is configured to maintain a database query result cache 112. As shown in FIG. 1, the database query result cache 112 includes one or more entries 114 where the database query result 108 for a database query 106 is stored. By storing a database query result 108 in the query result cache 112, the application 102 may utilize the database query result 108 stored in the query result cache 112 rather than querying the database server 104. Invalid entries in the query result cache 112 are deleted from the query result cache 112. FIG. 2, described below, illustrates this process in greater detail.

FIG. 2 is a flow diagram showing a routine 200 that illustrates aspects of one process for caching database query results. It should be appreciated that the logical operations described herein with respect to FIG. 2 and the other FIGURES are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

The routine 200 begins at operation 202, where the application 102 receives or generates a database query 106. As discussed above, the application 102 may generate the database query 106 or may receive the database query 106 from another software component. In response to receiving or generating the database query 106, the routine 200 proceeds to operation 204, where the application 102 determines whether the query result cache 112 contains an entry 114 for the database query 106. If an entry 114 in the query result cache 112 corresponding to the database query 106 is found, the routine 200 proceeds from operation 204 to operation 206. At operation 206, the application 102 utilizes the database query result 108 from the query result cache 112 rather than submitting the database query 106 to the database server 104. From operation 206, the routine 200 proceeds to operation 216, where it ends.

If, at operation 204, the application 102 determines that the query result cache 112 does not contain an entry 114 for the database query 106, the routine 200 proceeds from operation 204 to operation 208. At operation 208, the application 102 submits the database query 106 to the database server 104 for processing. In response thereto, the database server 104 executes the database query 106 against the database 110 and returns the database query result 108 to the application 102. The application 102 receives the database query result 108 from the database server 104 at operation 210.

In response to receiving the database query result 108, the application 102 creates an entry 114 in the query result cache 112 for the database query 106 and stores the database query result 108 in the created entry 114. The routine 200 then proceeds to operation 214, where the database query result 108 received from the database server 104 is utilized by the application 102 in the desired manner. From operation 214, the routine 200 proceeds to operation 216, where it ends.

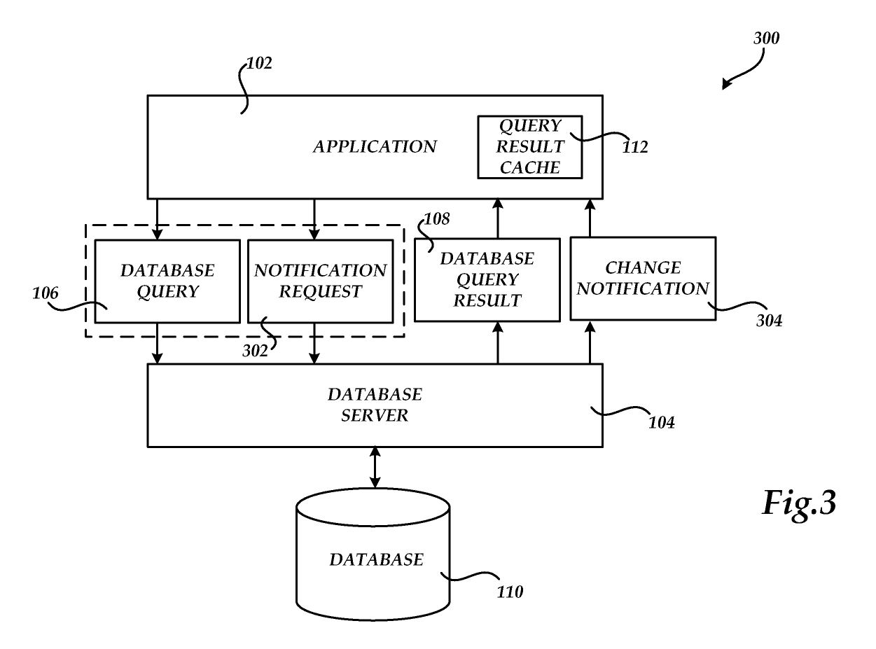

Referring now to FIG. 3, a system 300 will be described in which the application 102 utilizes a change notification feature provided by the database server 104 to invalidate entries in the query result cache 112. As discussed briefly above, certain database server programs provide functionality for registering a database query for a change notification. A change notification is an asynchronous notification that is provided by the database server 104 to the application 102 when the data underlying a registered database query changes. Through the use of change notifications and the query result cache 112, unnecessary database queries can be avoided for data that does not change or that only changes infrequently. FIG. 3 illustrates one system 300 that supports the use of a change notification provided by the database server to invalidate entries in the query result cache 112.

In order to utilize the change notifications provided by the database server 104, the application 102 submits a database query to the database server 104. The application 102 also submits a notification request 302 with the database server 104. The notification request 302 is a request on behalf of the application 102 for a change notification 304 from the database server 104 in the event that the data underlying the database 106 changes.

In response to receiving the database query 106, the database server 104 executes the database query 106 against the database 110 and returns the database query result 108 to the application 102. As discussed above, an entry may be created in the query result cache 112 that includes the database query result 108. Subsequently, the database server 104 may detect a change to the data underlying the database query 106. In response thereto, the database server 104 is configured to provide a change notification 304 to the application 102. The change notification 304 may be provided asynchronously.

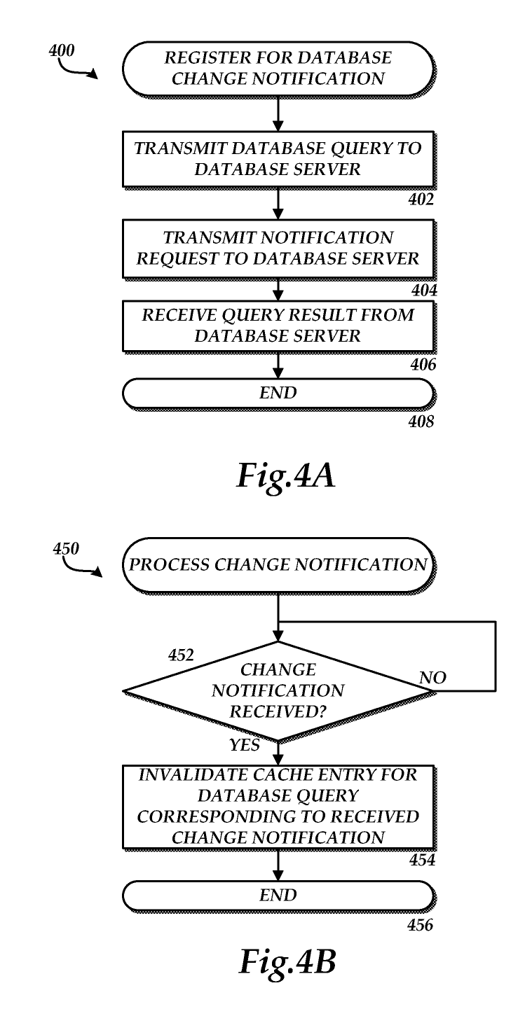

In response to receiving the change notification 304, the application 102 is configured to invalidate the entry in the query result cache 112 corresponding to the database query 106 for which change notification was requested. As discussed above, an entry in the query result cache 112 can be invalidated by deleting the entry from the query result cache 112. FIGS. 4A-4B illustrate this process in additional detail.

FIG. 4A is a flow diagram showing aspects of one illustrative process 400 by which an application 102 can register for a change notification 304 from a database server 104. The routine 400 begins at operation 402 where the application 102 transmits the database query 106 to the database server 104. The routine 400 then proceeds to operation 404, where the application 102 submits the notification request 302 to the database server 104. As discussed above, the notification request 302 comprises a request on behalf of the application 102 for a change notification 304 in the event that the database server 104 detects that the data in the database 110 underlying the database query 106 has changed. It should be appreciated that, in one implementation, the operations 402 and 404 are combined into a single operation.

In response to the submission of the database query 106 to the database server 104, the application 102 receives the database query result 108. As discussed above, an entry may be created in the database query result cache 112 for the database query 106 and the database query result 108. Subsequent requests to perform the database query 106 may be satisfied from the database query result cache 112 until the entry corresponding to the database query 106 has been invalidated. From operation 406, the routine 400 proceeds to operation 408, where it ends.

FIG. 4B shows an illustrative process 450 performed by the application 102 for processing the receipt of the change notification 304. The routine 450 begins at operation 452 where the application 102 determines whether a change notification 304 has been received from the database server 114. If not, the routine 450 proceeds back to operation 452 where another such determination is made. If a change notification 304 is received, the routine 450 proceeds to operation 454 where the application 102 invalidates the entry in the query result cache 112 for the database query 106 corresponding to the received change notification 304. Once the entry in the query result cache 112 for the database query 106 corresponding to the change notification 304 has been invalidated, the routine 450 proceeds to operation 456, where it ends. It should be appreciated that the operations illustrated in FIG. 4B may be performed using asynchronous notifications and without performing a program loop in order to determine whether a change notification has been received.

As discussed briefly above, certain types of database queries are ineligible for change notifications provided by the database server 104. For instance, database queries that include aggregates, multiple queries, that include unions, or that write back to the database 110 may be ineligible for a change notification. In order to address this difficulty, embodiments presented herein provide a mechanism by which change notifications can be provided for database queries that are ineligible for change notifications provided by the database server 104. Through the use of this mechanism, the application 102 can determine whether the data underlying a database query that is ineligible for a change notification has changed without polling the database server 104 to determine if the data has changed. The results of this determination can then be utilized to invalidate entries in the query result cache 112.

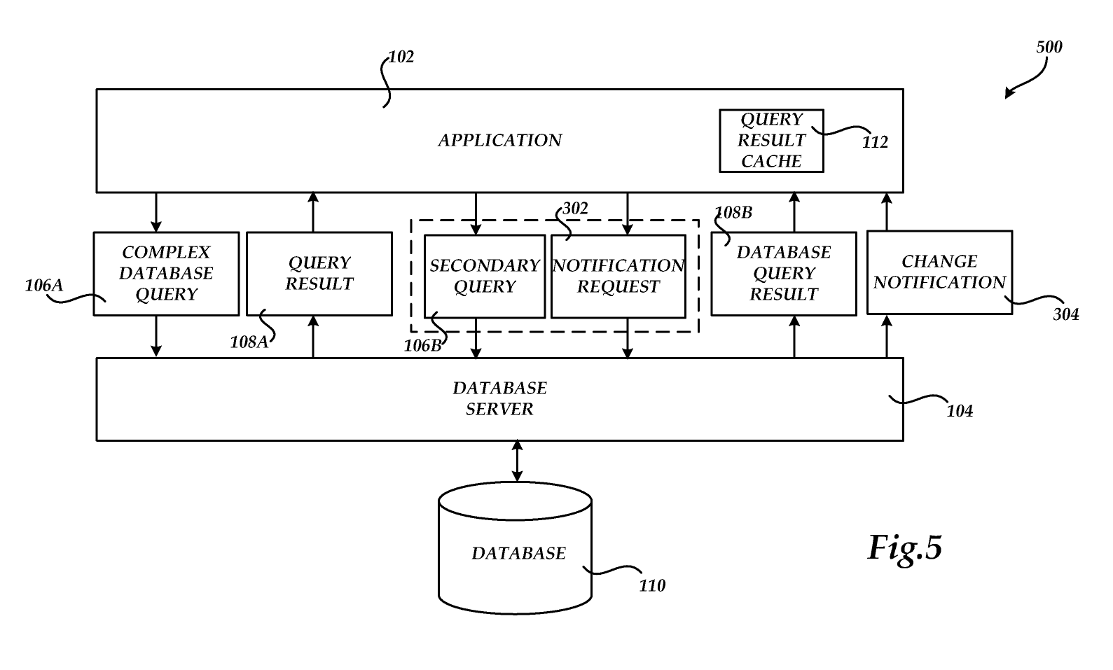

The system 500 illustrated in FIG. 5 shows aspects of one process performed by the application 102 for invalidating entries in the query result cache 112 for a complex database query 106A. When the application 102 receives or generates a complex database query 106A, the complex database query 106A is submitted to the database server 104 for processing. In response thereto, the database server 104 executes the complex database query 106A against the database 110 and returns the query result 108A to the application 102. In response thereto, the application 102 creates an entry in the query result cache 112 for the complex database query 106A.

In order to determine whether the data underlying the complex database query 106A has changed and therefore that the entry in the query result cache 112 is no longer valid, the application 102 submits a secondary query 106B to the database server 104 along with a change notification 302 for the secondary query 106B. In this way, the database server 104 is configured to provide a notification 304 to the application 102 in the event that the data underlying the secondary query 106B changes.

According to one implementation, the secondary query 106B is configured to return a superset of the set of data returned by the complex database query 106A. In one particular implementation, the secondary query 106B is configured to return a minimal superset of the set of data returned by the complex database query 106A. Additionally, the secondary query 106B is configured in a manner that permits it to remain eligible for a change notification 304 from the database server 104.

In response to processing the secondary query 106B, the database server 104 executes the secondary query 106B against the database 110 and returns the database query results 108B to the application 102. In response to receiving the database query result 108B, the application 102 creates an entry in the query result cache 112. Subsequently, if the database server 104 determines that the data underlying the secondary query 106B has changed, the database server 104 will issue the change notification 304 to the application 102.

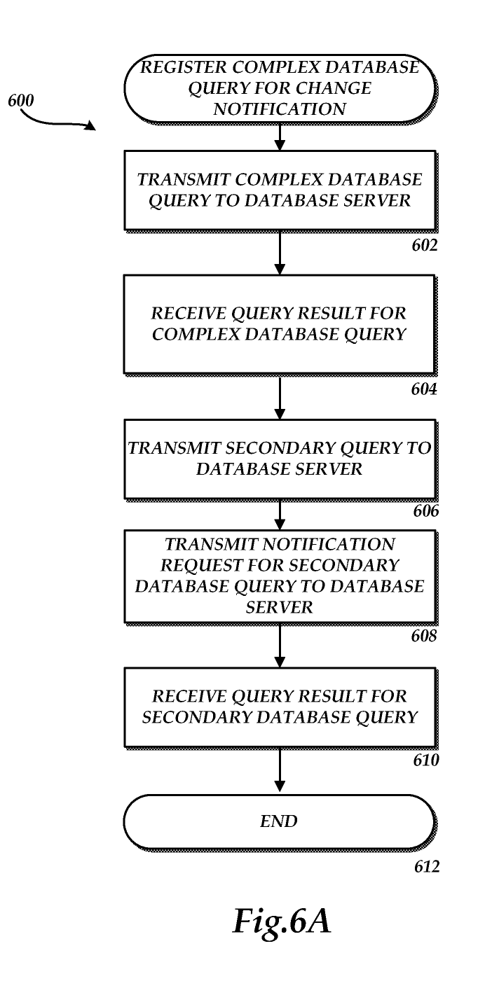

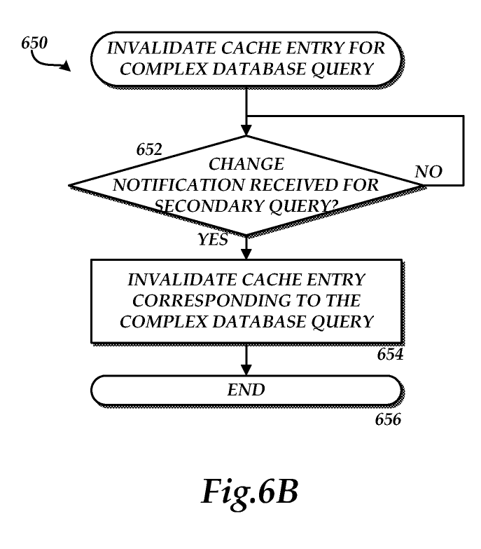

In response to receiving the change notification 304, the application 102 invalidates the entry in the query result cache 112 for the complex database query 106A. In this manner, the change notification 304 for the secondary query 106B is utilized to invalidate an entry in the query result cache 112 for the complex database query 106A. Additional details regarding this process are described below with reference to FIGS. 6A-6B.

FIG. 6A shows one illustrative process 600 for registering a complex database query 106A for a change notification 304. In particular, the routine 600 begins at operation 602 where the application 102 submits the complex database query 106A to the database server 104. In response thereto, the application 102 receives the query result 108 for the complex database query 106A from the database server 104. The query result 108A is then utilized to create an entry in the query result cache 112.

From operation 604, the routine 600 proceeds to operation 606 where the application 102 submits the secondary query 106B to the database server 104. As discussed above, the secondary query 106B is configured to return a superset of the set of data returned by the complex database query 106A. Additionally, the application 102 submits a notification request 302 for the secondary query 106B to the database server 104 at operation 608. In response to the submission of the secondary query 106B, the application 102 receives the database query result 108B from the database server 104 at operation 610. The database query result 108B for the secondary query 106B are not utilized. The routine 600 then proceeds to operation 612, where it ends.

FIG. 6B shows one illustrative process 650 for invalidating an entry in the query result cache 112 for the complex database query 106A. The routine 650 begins at operation 652, where the application 102 determines whether a change notification 304 has been received from the database server 104 for the secondary query 106B. If not, the routine 650 proceeds back to operation 652 where the determination is made once again. If a change notification 304 is received for the secondary query 106B, the routine 650 proceeds to operation 654. At operation 654, the application 102 invalidates the entry in the query result cache 112 corresponding to the complex database query 106A. Once the entry in the query result cache 112 has been invalidated, the routine 650 proceeds to operation 656, where it ends.

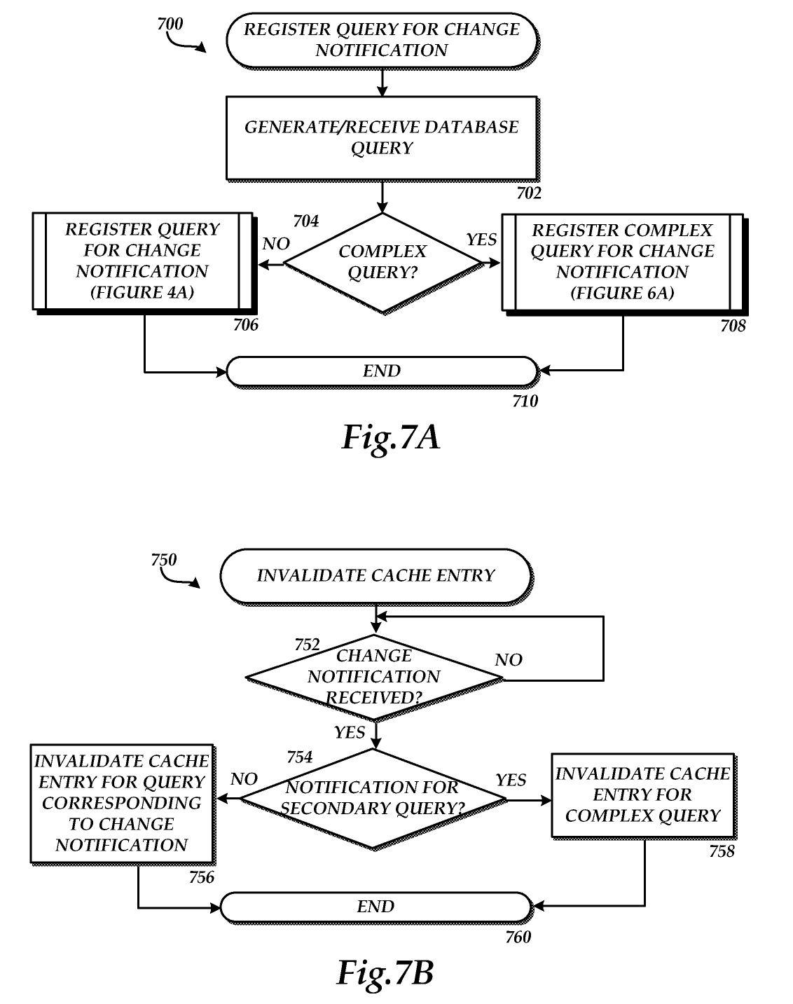

FIG. 7A shows an illustrative routine 700 for registering an arbitrary database query for a change notification with the database server 104. The routine 700 begins at operation 702, where the application 102 generates or receives a database query. In response thereto, the application 102 determines whether the received or generated database query is a complex query at operation 704. As discussed above, a complex database query is a query that is ineligible for a change notification from the database server 104.

If the received or generated query is not a complex query, the routine 700 proceeds from operation 704 to operation 706. At operation 706, the database query is registered for a change notification in the manner discussed above with reference to FIG. 4A. Because the received database query is not a complex database query, the database query can be directly registered with the database server 104 for a change notification. From operation 706, the routine 700 proceeds to operation 710, where it ends.

If, at operation 704, the application 102 determines that the received or generated database query is a complex database query, the routine 700 proceeds from operation 704 to operation 708. At operation 708, the application 102 registers the database query for a change notification in the manner described above with reference to FIG. 6A. Because the received or generated database query is a complex database query, a secondary query 106B is utilized to obtain the change notification 304. From operation 708, the routine 700 proceeds to operation 710, where it ends.

FIG. 7B shows one illustrative process 750 for invalidating an entry in the query result cache 112 in response to receiving an arbitrary change notification from the database server 104. In particular, the routine 650 begins at operation 752, where the application 102 determines whether a change notification 304 has been received from the database server 104. If not, the routine 750 returns to operation 752 where another such determination is made. If a change notification is received, the routine 750 proceeds to operation 754 where the application 102 determines whether the received change notification 304 corresponds to a secondary query 106B. If not, the routine 750 proceeds to operation 756 where the application 102 invalidates the entry in the query result cache 112 for the database query corresponding to the received change notification 304. From operation 756, the routine 750 proceeds to operation 760, where it ends.

If, at operation 754, the application 102 determines that the received change notification 304 corresponds to a secondary query 106B, the routine 750 proceeds to operation 758. At operation 758, the application 102 invalidates the entry in the query result cache 112 corresponding to the complex database query 106A associated with the secondary query 106B. From operation 758, the routine 750 proceeds to operation 760, where it ends.

It should be appreciated that, according to one implementation, the notification mechanism described herein may be utilized to control the caching of output by a World Wide Web (“Web”) server application program. According to this implementation, a change notification 304 for a secondary query 106B may be utilized by the application 102 to instruct a Web server application program not to regenerate output until such time as the entry in the query result cache 112 corresponding to the secondary query 106B has been invalidated. In this way, the Web server can be instructed not to reprocess an output Web page until the database data underlying the Web page has been modified. In this manner, the Web server will cache its generated output until the underlying data stored in the database 110 changes.

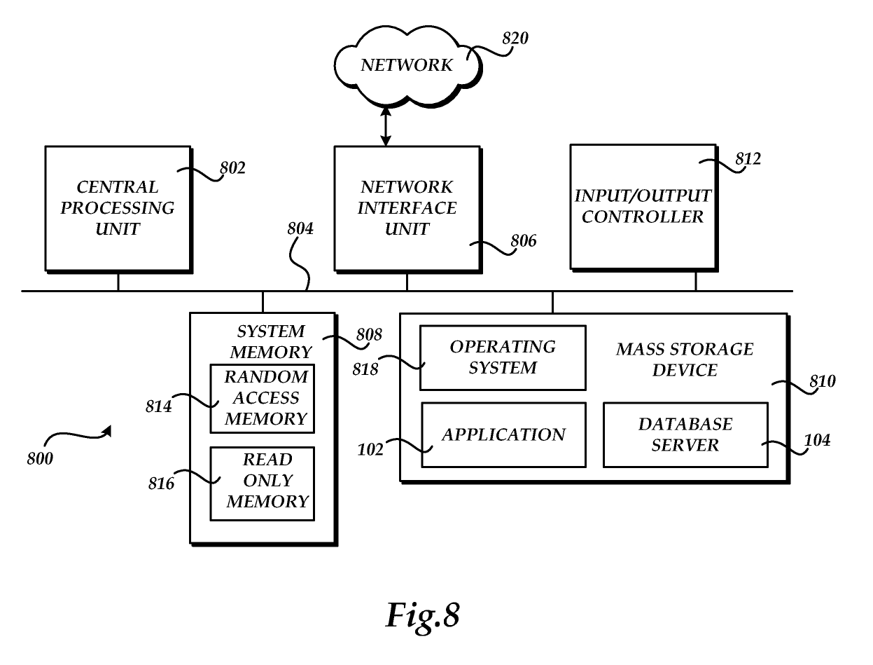

FIG. 8 shows an illustrative computer architecture for a computer 800 capable of executing the software components described herein. The computer architecture shown in FIG. 8 illustrates a conventional desktop, laptop, or server computer and may be utilized to execute any aspects of the software components presented herein.

The computer architecture shown in FIG. 8 includes a central processing unit 802 (“CPU”), a system memory 808, including a random access memory 814 (“RAM”) and a read-only memory (“ROM”) 816, and a system bus 804 that couples the memory to the CPU 802. A basic input/output system containing the basic routines that help to transfer information between elements within the computer 800, such as during startup, is stored in the ROM 816. The computer 800 further includes a mass storage device 810 for storing an operating system 818, application programs, and other program modules, which are described in greater detail herein.

The mass storage device 810 is connected to the CPU 802 through a mass storage controller (not shown) connected to the bus 804. The mass storage device 810 and its associated computer readable storage media provide non-volatile storage for the computer 800. Although the description of computer readable storage media contained herein refers to a mass storage device, such as a hard disk or CD-ROM drive, it should be appreciated by those skilled in the art that computer storage media can be any available computer storage media that can be accessed by the computer 800.

By way of example, and not limitation, computer readable storage media may include volatile and non-volatile, removable and non-removable media implemented in any method or technology for storage of information such as computer readable and executable instructions, data structures, program modules or other data. For example, computer storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 800.

According to various embodiments, the computer 800 may operate in a networked environment using logical connections to remote computers through a network such as the network 820. The computer 800 may connect to the network 820 through a network interface unit 806 connected to the bus 804. It should be appreciated that the network interface unit 806 may also be utilized to connect to other types of networks and remote computer systems. The computer 800 may also include an input/output controller 812 for receiving and processing input from a number of other devices, including a keyboard, mouse, or electronic stylus (not shown in FIG. 8). Similarly, an input/output controller may provide output to a display screen, a printer, or other type of output device (also not shown in FIG. 8).

As mentioned briefly above, a number of program modules and data files may be stored in the mass storage device 810 and RAM 814 of the computer 800, including an operating system 818 suitable for controlling the operation of a networked desktop, laptop, or server computer. The mass storage device 810 and RAM 814 may also store one or more program modules. In particular, the mass storage device 810 and the RAM 814 may store the application 102 and the database server 104, each of which was described in detail above with respect to FIGS. 1-7B. The mass storage device 810 and the RAM 814 may also store other types of program modules and data.

It should be appreciated that the software components described herein may, when loaded into the CPU 802 and executed, transform the CPU 802 and the overall computer 800 from a general-purpose computing system into a special-purpose computing system customized to facilitate the functionality presented herein. The CPU 802 may be constructed from any number of transistors or other discrete circuit elements, which may individually or collectively assume any number of states. More specifically, the CPU 802 may operate as a finite-state machine in response to executable instructions contained within the software modules disclosed herein. These computer-executable instructions may transform the CPU 802 by specifying how the CPU 802 transitions between states, thereby transforming the transistors or other discrete hardware elements constituting the CPU 802.

Encoding the software modules and data presented herein might also transform the physical structure of the computer storage media presented herein. The specific transformation of physical structure may depend on various factors, in different implementations of this description. Examples of such factors may include, but are not limited to: the technology used to implement the computer storage media, whether the computer storage media is characterized as primary or secondary storage, and the like. For example, if the computer storage media is implemented as semiconductor-based memory, the software disclosed herein may be encoded on the computer readable storage media by transforming the physical state of the semiconductor memory. For example, the software may transform the state of transistors, capacitors, or other discrete circuit elements constituting the semiconductor memory. The software may also transform the physical state of such components in order to store data thereupon.

As another example, the computer storage media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer 800 in order to store and execute the software components presented herein. It also should be appreciated that the computer 800 may comprise other types of computing devices, including hand-held computers, embedded computer systems, personal digital assistants, and other types of computing devices known to those skilled in the art. It is also contemplated that the computer 800 may not include all of the components shown in FIG. 8, may include other components that are not explicitly shown in FIG. 8, or may utilize an architecture completely different than that shown in FIG. 8.

Based on the foregoing, it should be appreciated that technologies for notification-based cache invalidation for complex database queries have been disclosed herein. Although the subject matter presented herein has been described in language specific to computer structural features, methodological and transformative acts, specific computing machinery, and computer storage media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer-implemented method for invalidating an entry in a database query result cache corresponding to a complex database query, the method comprising performing computer-implemented operations for:
registering a secondary database query with a database server for a change notification;
receiving a change notification from the database server for the secondary database query; and
invalidating the entry in the database query result cache corresponding to the complex database query in response to receiving the change notification for the secondary database query.

2. The computer-implemented method of claim 1, wherein the complex database query comprises a database query that is ineligible for a change notification from the database server.

3. The computer-implemented method of claim 2, wherein the secondary database query comprises a database query that is eligible for a change notification from the database server.

4. The computer-implemented method of claim 3, wherein the complex database query is configured to return a set of data and wherein the secondary database query further comprises a database query that is configured to return a superset of the set of data returned by the complex query.

5. The computer-implemented method of claim 4, wherein the change notification is generated in response to detecting a change in the superset of the set of data returned by the complex query.

6. The computer-implemented method of claim 5, wherein invalidating the entry in the database query result cache for the complex database query comprises deleting the entry in the database query result cache corresponding to the complex database query.

7. The computer-implemented method of claim 6, further comprising:
receiving a database query;
searching the database query result cache for an entry corresponding to the received database query; and
in response to locating an entry in the query result cache corresponding to the received database query, returning a query result from the database query result cache in response to receiving the database query.

8. The computer-implemented method of claim 7, wherein the complex database query and the secondary database query comprise structured query language (SQL) queries.

9. A computer readable storage medium having computer executable instructions stored thereupon which, when executed by a computer, cause the computer to:
receive a database query;
in response to receiving the database query, to determine whether the database query is a complex database query ineligible for a change notification provided by a database server; and to register a secondary database query with the database server for the change notification in response to determining that the database query is a complex database query ineligible for a change notification from the database server.

10. The computer-readable storage medium of claim 9, having further computer executable instructions stored thereupon which, when executed by the computer, cause the computer to:
receive a change notification from the database server for the secondary database query; and to invalidate an entry in a database query result cache corresponding to the complex database query in response to receiving the change notification for the secondary database query.

11. The computer-readable storage medium of claim 10, having further computer executable instructions stored thereupon which, when executed by the computer, cause the computer to register the database query with the database server for the change notification in response to determining that the database query is not a complex database query that is ineligible for a change notification.

12. The computer-readable storage medium of claim 11, wherein the complex database query is configured to return a set of data and wherein the secondary database query further comprises a database query that is configured to return a superset of the set of data returned by the complex query.

13. The computer-readable storage medium of claim 12, wherein the change notification is generated in response to detecting a change in the superset of the set of data returned by the complex query.

14. The computer-readable storage medium of claim 13, wherein invalidating the entry in the database query result cache for the complex database query comprises deleting an entry in the database query result cache corresponding to the complex database query.

15. The computer-readable storage medium of claim 14, having further computer executable instructions stored thereupon which, when executed by the computer, cause the computer to:
receive a second database query;
search the database query result cache for an entry corresponding to the second database query; and to
return a query result from the database query result cache in response to the second database query in response to locating an entry in the query result cache corresponding to the second database query.

16. The computer-readable storage medium of claim 15, wherein the complex database query and the secondary database query comprise structured query language (SQL) queries.

17. A computer-implemented method for invalidating an entry in a database query result cache corresponding to a complex database query, the method comprising performing computer-implemented operations for:
receiving a database query;
in response to receiving the database query, determining whether the database query is a complex database query ineligible for a change notification provided by a database server;
registering the database query with the database server for the change notification in response to determining that the database query is not a complex database query that is ineligible for the change notification;
registering a secondary database query with the database server for the change notification in response to determining that the database query is a complex database query ineligible for a change notification from the database server;
receiving the change notification from the database server for the secondary database query;
invalidating the entry in the database query result cache corresponding to the complex database query in response to receiving the change notification for the secondary database query;
receiving a second database query;
searching the database query result cache for an entry corresponding to the second database query; and
in response to locating an entry in the database query result cache corresponding to the second database query, returning a query result from the database query result cache in response to the second database query.

18. The computer-implemented method of claim 17, wherein the complex database query is configured to return a set of data and wherein the secondary database query further comprises a database query that is configured to return a superset of the set of data returned by the complex query.

19. The computer-implemented method of claim 18, wherein the change notification is generated in response to detecting a change in the superset of the set of data returned by the complex query.

20. The computer-implemented method of claim 19, wherein the complex database query and the secondary database query comprise structured query language (SQL) queries.
